(19) United States
(12) Patent Application Publication
(10) Pub. No.: US 2005/0198242 A1
(43) Pub. Date: Sep. 8, 2005

(54) System and method for detection/interception of IP collision

(75) Inventor: Chanwoo Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: ViaScope Int.

(21) Appl. No.: 10/751,567

(22) Filed: Jan. 5, 2004

(51) Int. Cl. G06F 15/173

(52) U.S. Cl. 709/223

(57) ABSTRACT

The present invention relates to detecting and analyzing interrupted ARP (Address Resolution Protocol) packets occurring when an IP communication is established in a network. The invention refers to IP collision detection and access blocking methods using ARP. The present invention monitors network traffic packets, detects packet collisions and notifies administrators on the status, and depending on network policies, blocks IP users' network access using ARP centered on MAC.

### BACKGROUND OF THE INVENTION

1) Field of the Invention

The present invention relates to detecting and analyzing interrupted ARP (Address Resolution Protocol) packets occurred when IP communication is established in a network. It monitors network traffic packets, detects packet collisions whenever ARP packets are collected and notifies administrators on the status, and depending on network policies, blocks IP users' network access using ARP centered on MAC.

2) Brief Description of the Prior Art

General ARP usages are as follows.
1. Transmitting party, who is a host, would like to transmit packets to another host within the same network. In such case, the logical address that needs to be converted to physical address is the destination IP address contained in the packet header.
2. Transmitting party, who is a host, would like to transmit packets to another host who is on a different network. In such case, the host uses a routing table to search for the IP address of the next hop (router) for the destination. If it is not in the routing table, it will search for the IP address of a default router. The router's IP address becomes the logical address that converts to a physical address.
3. Transmitting party is a router that has received packets for a host on a different network. The router will refer to a routing table to search for the IP address of the next hop router. The IP address of the next router is the logical address that converts to a physical address.
4. Transmitting party is a router that has received packets for a host within the same network. Packet's destination IP is the logical address that converts to a physical address.

When viewing ARP execution process, transmitting party knows the target IP address, which is acquired through the following process.
1. IP requests to generate ARP request message. In the requesting message, the physical address (MAC) and IP address of the transmitting party and the destination IP address are filled, but the destination's physical (MAC address) field is filled with ‘0’.
2. The message is transmitted to data link layer, and it frames the transmitting party's physical address to sender's address and physical broadcast address to the destination address.
3. All hosts and routers receive the frame, and since the frame contains the broadcast destination address, all hosts transmit the message to their ARP.
4. The destination sends ARP message respond, that includes its physical address, and the message is unicasted.
5. The transmitting party finds out the destination's physical address by receiving the responding message.
6. The IP packet that contains the data to be sent to the destination is being made into frames and unicasted to the destination.

Practically, new hosts (ex. new PC/notebook/external user/network devices addition), who are unknown to administrators, access and use the network at anytime. Therefore, from the administrator's perspective, he should be able to find out and control the access of IP addresses for additional network devices and unauthorized users. By doing so, the administrator can easily manage the network resources.

Therefore, it is important for administrators to effectively manage IP address resource management per network user (host). However, it is currently difficult to keep track of IP address being assigned to each host and find out if the host is using originally assigned IP, since hosts can freely change IP address settings.

There have been proposed various methods of managing and controlling IP, but no concrete solution has been yet proposed and commercialized.

Traditional way of detecting IP collision is to view the collision message created by collided hosts' system. However, network administrators will not be able to check the status and be able to newly assign an IP that would not create another collision. In other words, administrators will not find out IP collisions until one of the collided hosts notifies them.

It is impossible to predict when and how a malicious host would access the network to steal network information. There is no particular method to find out the status.

The above difficulty leads to IP management absences. Also, collecting information on each IP user is needed, but it's also missing.

### SUMMARY OF THE INVENTION

Accordingly, an object of the present invention is to provide a system and method for allowing network administrators to more efficiently manage IP and resolve management problems by analyzing ARP packet to monitor IP users in real time, detect collisions and control/block the access. More specifically, when ARP packets are transmitted, the inventive system interrupts and analyzes each ARP packet, and creates an IP table list to detect IP collision. It also informs the administrators of the status in order to easily manage IP and monitor and block the network access of illegal hosts.

To achieve the above object, in one aspect, there is provided a system for detection and blocking of IP collision, including: a communication interface and communication kernel module that provides communication interface that enables a collided IP detection system to share information with other hosts and provides a kernel for controlling the communication; a network interface driver module that is connected with a physical device that is a network interface and an upper communication module to transmit packets to the network, and transmits packets collected in the network to the upper communication module; a network interface module that is connected to the devices connected to the network; a packet capture driver module that collects all packets detected in the network; an ARP packet filtering module that filters only ARP packets among the packets being captured from the packet capture driver module; an IP collision decision module that determines if the collected packets are collided IP packets and, if so, transmits the results to a listing module; an access blocking decision module that notifies an access status if an ARP request packet is included in an access blocking policy list; an access blocking module that, depending on the access blocking decision module's decision to block the access on a particular packet, blocks the network access by transmitting the ARP respond packet to the blocked packet; a data storage module that stores information set to operate the collided IP detection system, a detected collided IP list, and a newly detected host's IP and MAC address lists; a search list logging and saving module that internally lists the detected collided IP data and periodically it saves in a storage medium; and a detection result notification module that transmits the detected collided IP data to other system and notifies the administrator of it, wherein when the ARP packet is collected from the network, each ARP packet is classified into a request packet and a respond packet after being identified, and then if it is a new request packet, it is added to the list, but if it is a respond packet that also exists in input request ARP packet list, the packet's collision is detected and at the same time the ARP packet's access is blocked.

According to the above configuration, the present invention is composed of a single system that can execute the functions by installing a single IP network point. As a result, it provides convenience in manager's operation as well as low costs for the owner and minimizes deployment risks.

### BRIEF DESCRIPTION OF THE DRAWINGS

FIG. 1 is a block diagram illustrating the construction of an IP collision detection & access blocking system according to the present invention;

FIG. 2 is a block diagram illustrating IP collision detection & access blocking processes according to the present invention;

FIG. 3 is a flow chart illustrating an IP collision detection process according to the present invention; and

FIG. 4 is a flow chart illustrating an access blocking process according to the present invention.

### DETAILED DESCRIPTION OF THE PREFERRED EMBODIMENTS

The present invention will now be described in detail in connection with preferred embodiments with reference to the accompanying drawings.

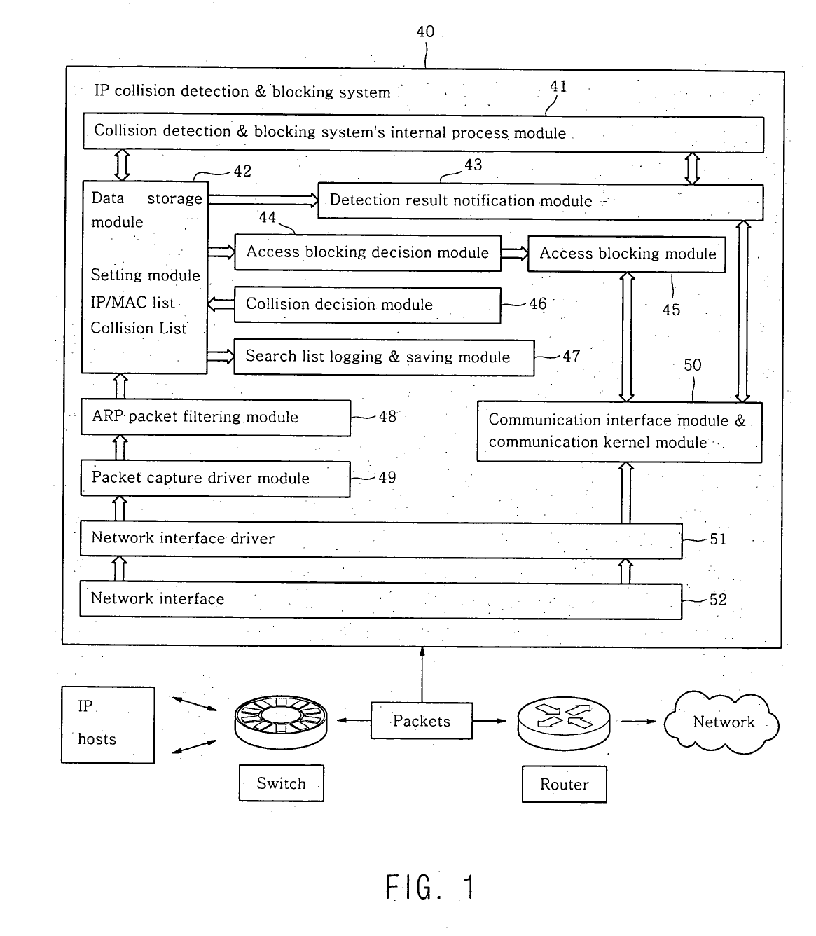

Referring to FIG. 1, the present invention's includes a process module (41), a data storage module (42), a detection result notification module (43), an access blocking decision module (44), an access blocking module (45), a search list logging & saving module (46), an IP collision decision module (47), an ARP packet filtering module (48), an packet capture driver module (49), an communication interface module & communication kernel module (50), an network interface driver module (51) and a network interface module (52).

The process module (41) refers to the IP collision detection system's internal process module which provides a user's interface for system operations.

The data storage module (42) refers to the storage area which saves the system settings and IP and MAC addresses of the detected IP collision which is required for the IP collision detection system operations. It operates with basic memory and when the program ends, it saves the information to an unused area, which can be reused later.

The detection result notification module (43) refers to the module that transmits detected IP collision information to another system and notifies administrators on the status using sound, blinking and simple messages.

The access blocking decision module (44) determines the network access allowances on existing and new hosts detected in the system to execute access control. The information to make decisions for this module is based on the information provided by data storage module (42) and policy definitions designed to apply blocking.

Depending on the decisions made by the access blocking decision module (44), access blocking module (45) sends unicast or broadcast ARP respond packets to the designated host in order to create collision or change the MAC address on ARP table using a 2nd MAC address. As a result, it executes the blocking policy by preventing the connection of the blocked host trying to connection.

The search list logging and saving module (46) lists already detected IP collision information internally and stores periodically the details in another storage device.

The IP collision decision module (47) determines if the collected ARP packets are IP collided packets. If the collected ARP packet is an IP collided packet, it transmits the results to the search list logging and saving module (46) to be saved therein.

The ARP packet filtering module (48) does not process all the packets. It only uses an ARP packet, and discards all other packets. It transmits all filtered ARP packets' information to the data storage module (42).

The packet capture driver module (49) collects all packets detected on the network and transmits them to the ARP packet filtering module (48), as well as the filtering module (48) filters only the ARP packets and transmit them to the data storage module (42).

The communication interface and communication kernel module (50) executes tasks which provides the kernel to control the communication when the IP collision detection and blocking system provides communication interface for sending and receiving other hosts' information.

The network interface driver module (51) connects the physical device which is the network interface with an upper communication module to transmit packets to the network. It is also responsible for transmitting received network packets to the upper communication module.

The network interface module (52) is the connector that is connected to the network.

As mentioned above, when operational information is entered from the IP collision detection and blocking system's internal process module (41), the operational information, which is the setting information and IP collision list, are determined based on the data storage module (42), which then transmits the setting information and decision on whether to send the detected results of the detection result notification module (43) to the other system.

The above data storage module (42) received information from the search list logging and save module (46) and stores the updated IP collision list, and at the same time, if the search result notification module (43) requests the operational information received from process module (41), the requested information is transmitted.

The above IP collision decision module (45) make decisions on IP collisions based on filtered ARP packets received from ARP packet filtering module (48). Depending on access blocking policies defined in per IP′ MAC address list included in the data storage module (42), the access blocking decision module (44) decides whether to block or allow the received ARP packet and block the ARP packet using access blocking module (45).

Also, the packet capture driver module (49) transmits all packets received from the network interface driver module (51) to the ARP packet filtering module (48). The network interface driver module (51) then receives the upper packet sent from the communication interface and communication kernel module (50) and lower packets from network interface module (52).

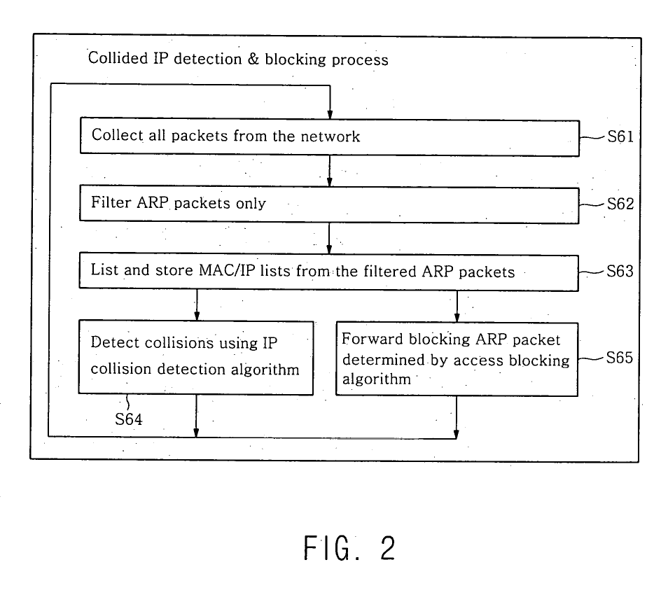

FIG. 2 shows ARP packet flow to detect IP collision and block access, which describes how the ARP packet is collected, and how the IP collision is detected as well as access is blocked in a general IP network environment.

Referring to FIG. 2, the collided IP detection and blocking method of the present invention is shown in step S61. the packet capture driver module (49) captures all packets detected in the IP networking environment, transmits them to the ARP packet filtering module (48), and only ARP packets are filtered at the filtering module (48) for transmission for the data storage module (42).

In step S62, using the ARP packet filtering module (48), it only filters the ARP packets from those packets collected in step S61. In step S62, basic information is required to detect IP collisions and execute blocking policies using the ARP packet. The filtered packets are transmitted to the next step.

In Step S62, ARP packets created by a host used to establish communication with another host needed to find out the destination host's physical address (MAC) are filtered, which will be used as base information to determine IP collision status for internal IP hosts.

In step S63, it filters the ARP request packets only from those ARP packets filtered by the ARP packet filtering module (48) in step S62, extracts the host's IP and MAC address information, lists them, and acts as the basic database used to detect IP collisions and block the access.

In step 64, based on the ARP packet list filtered through ARP packet filtering module (48), it executes the collided IP detection process using IP collision decision module (47). In the present invention, when IP/MAC addresses are added to the list, and the ARP respond message occurs more than 3 times within the time out period (time out period: 1 to 2 seconds), it is determined that a host with the same IP address exists in the network.

Step 65 executes access blocking tasks, based on the list created in step S63, using access blocking module (45). It blocks and controls each host's access by defined network access policies. Access control policies can be defined by a group and/or per host level.

Based on the decision made by previous access blocking decision module (44), the access blocking module (45) sends out unicast or a broadcast ARP respond packet to create collision or to use a 2nd MAC to change the MAC address in the ARP table.

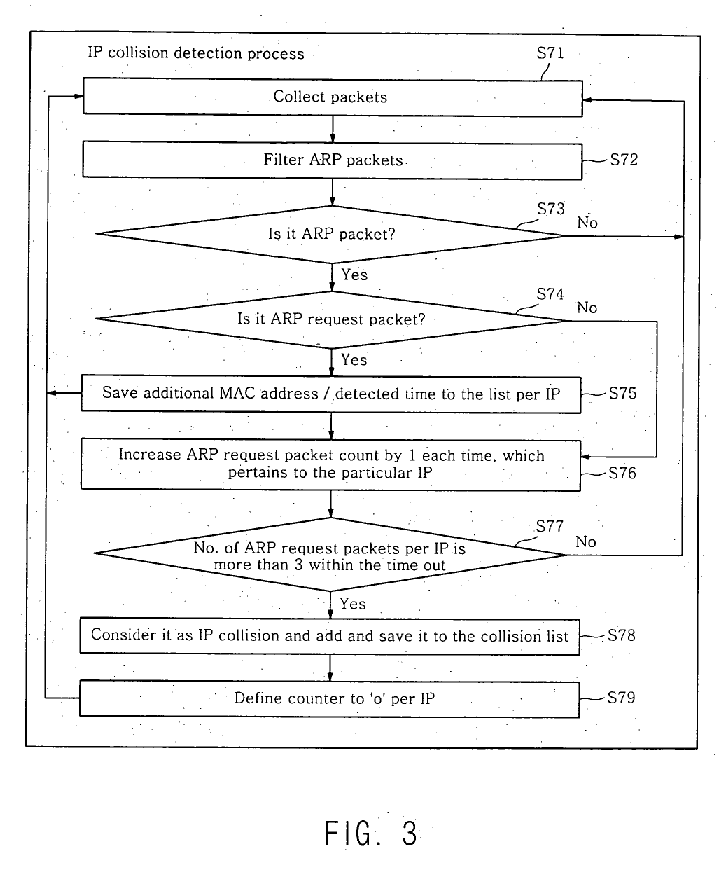

Referring to FIG. 3, the invention collects (S71) all the packets detected by the IP collision detection system (40) using the packet capture driver module (49). From then, only ARP packets will be filtered (S72) from all the packets collected using the ARP packet filtering module (48), and ARP packet status will be decided (S73) by the access blocking decision module (44).

In step S73, the ARP packet confirmation process is executed and all non-ARP packets are dropped. If an ARP packet is confirmed, filtered ARP packet will be judged if it is an ARP request packet or an ARP respond packet (S74). If it is the ARP request packet, new ARP request packet per IP will be searched using a MAC address, the information will then be saved to the host list along with the detected time. If the IP already exists in the list, the MAC and the detected time will updated and saved. The next packet is read (S75).

On the other hand, if the filtered packet is the ARP respond packet, step S76 will be executed. Step S76 is an ARP respond message process stage, which sends respond ARP packets when a host creates broadcasting packet to request an ARP request. This means that it is notifying that there is a host already using the particular IP in the network.

The detection system of the present invention is designed to check if an ARP respond packet is created more than three times within the given period. Therefore, in this stage, when an ARP respond packet is detected, each IP has an ARP respond packet generating counter, and the count is incremented by one each time.

Step S77 checks if there were more than 3 ARP respond packets generated for each IP within the given period (ex. time out period: 1-2 seconds) using collision decision module (47). It checks the respond ARP counter, and if it appears to be more than 3 times, it is determined that an IP collision has occurred, and collided IP and detail information will be stored (S78) to the collided list. If the counter is less than 3, it will reset the respond ARP counter to ‘0’ for each IP and then moves on to next packet (S79).

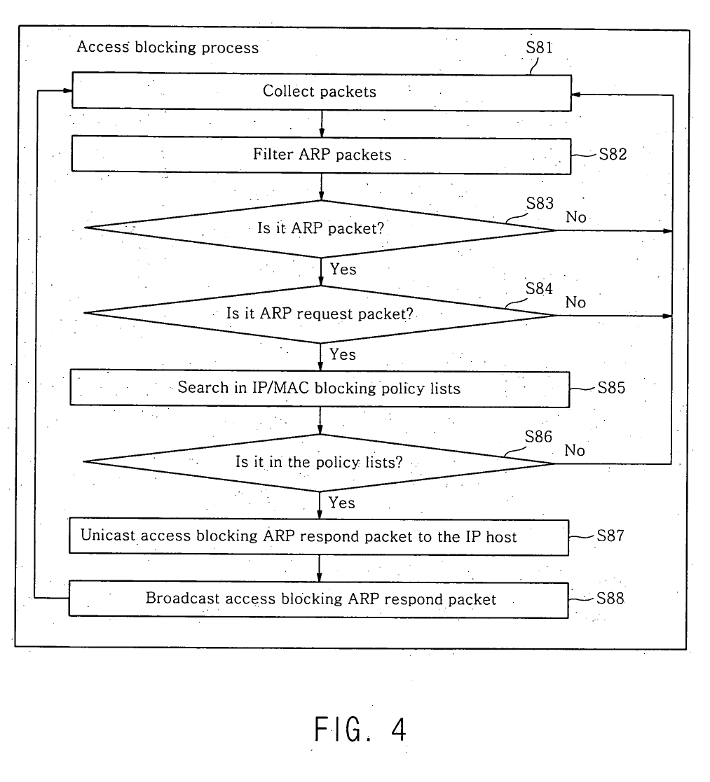

Referring to FIG. 4, the present invention collects (S81) all packets detected by the IP collision detection system (40), and filters the ARP packets using only the filtering (S82) process and then confirm if they are ARP packets (S83).

In step S83, it checks if the collected packets are ARP packets, and all non-ARP packets are dropped and moved on to next packet. If it is confirmed as an ARP packet, it checks if the ARP packet is an ARP request packet or ARP respond packet (S84).

Depending on the decision result, step 84 determines if it is ARP request packet. If so, it decides (S86) if the packet is under a blocking policy by searching through the IP or MAC blocking policy list (S85).

Based on the decision made in step S86, if the packet does not exist under the blocking policy list, it moves on to the next packet. On the contrary, if the packet is under the blocking policy list, it unicasts the ARP respond packet to the designated IP host, and block the host by broadcasting a respond ARP packet.

As described above, the present invention enables administrators to centrally manage IP addresses as well as control the network access in an IP networking environment. Furthermore, it enables a prompt response and resolution to IP collision detection. As a result, administrators will be able to offer higher quality of services to users (hosts).

1. A system for detection and blocking of IP collisions, comprising:
a communication interface and communication kernel module that provides a communication interface that enables a collided IP detection system to share information with other hosts and provides a kernel for controlling the communication;
a network interface driver module that is connected with a physical device that is a network interface and an upper communication module to transmit packets to the network, and transmits packets collected in the network to the upper communication module;
a network interface module that is connected to the devices connected to the network;
a packet capture driver module that collects all packets detected in the network;
an ARP packet filtering module that filters only ARP packets among the packets being captured from the packet capture driver module;
an IP collision decision module that determines if the collected packets are collided IP packets and, if so, transmits the results to a listing module;
an access blocking decision module that notifies an access status if an ARP request packet is included in an access blocking policy list;
an access blocking module that, depending on the access blocking decision module's decision to block the access on a particular packet, blocks the network access by transmitting an ARP respond packet to the blocked packet;
a data storage module that stores information set to operate the collided IP detection system, a detected collided IP list, and a newly detected host's IP and MAC address lists;
a search list logging and saving module that internally lists the detected collided IP data and periodically it saves in a storage medium; and
a detection result notification module that transmits the detected collided IP data to another system and notifies the administrator of it,
wherein when the ARP packet is collected from the network, each ARP packet is classified into a request packet and a respond packet after being identified, and then if it is a new request packet, it is added to the list, but if it is a respond packet that also exists in input request ARP packet list, the packet's collision is detected and at the same time the ARP packet's access is blocked.

2. A method of detecting IP collisions using an IP collision detection system between a client and a server, comprising the steps of:
collecting all packets created by accessing the network;
filtering only ARP packets among the collected packets;
determining whether the filtered ARP packet is an ARP request packet or an ARP respond packet;
adding a MAC address to a list by IP address if the filtered ARP packet is an ARP request packet;
incrementing a count by one each time if the filtered ARP packet is an ARP respond packet;
determining if the number of the ARP respond packets occurring by IP exceeds the frequency set within a predefined time out period, and if it exceeds the set frequency, confirming it as IP collision and adding it to the list; and
if the number of the ARP respond packets occurring are less than the set frequency, resetting each IP's counter.

3. A method of blocking collided IP using an IP collision blocking system between a client and a server, comprising the steps of:
collecting all packets transmitted over a network;
filtering only ARP packets among the collected packets;
determining whether the filtered ARP packet is an ARP request packet or an ARP respond packet;
confirming if an IP address and IP or MAC are included in a block policy list if the filtered packet is an ARP request packet;
unicasting the ARP respond packet to block access to a corresponding host if an ARP request packet is included in the policy list; and
broadcasting the ARP respond packet to block access after unicasting the ARP respond packet, thereby blocking the network access.
